(19) United States
(12) Patent Application Publication
(10) Pub. No.: US 2024/0413683 A1
(43) Pub. Date: Dec. 12, 2024

(54) SERIES CONNECTION OF MAGNET POCKETS TO IMPROVE AND SPEED UP THE FILLING AND VENTILATION PROCESS

(71) Applicant: Valeo eAutomotive Germany GmbH, Erlangen (DE)

(72) Inventors: Christoph WIECZOREK, Bad Neustadt a.d.Saale (DE); Markus RUBI, Bad Neustadt a.d.Saale (DE); Alexander SCHLERETH, Bad Neustadt a.d.Saale (DE); Kay LEMMERT, Bad Neustadt a.d.Saale (DE); Stephan HELLMUTH, Bad Neustadt a.d.Saale (DE); Robert WERNER, Bad Neustadt a.d.Saale (DE); Robin BÜSCH, Bad Neustadt a.d.Saale (DE); Sebastian DIETERICH, Bad Neustadt a.d.Saale (DE)

(73) Assignee: Valeo eAutomotive Germany GmbH, Erlangen (DE)

(21) Appl. No.: 18/696,111

(22) PCT Filed: Sep. 27, 2022
(86) PCT No.: PCT/EP2022/076847

§ 371 Date: Mar. 27, 2024

(30) Foreign Application Priority Data
Sep. 29, 2021 (DE) 10 2021 210 913.6

(51) Int. Cl. H02K 1/276; H02K 15/03

(52) U.S. Cl. CPC H02K 1/2766; H02K 15/03

(57) ABSTRACT

A rotor for an electric machine includes a laminated core formed from stacked electrical laminations and having magnet pockets arranged therein, a plurality of magnets, of which at least one is inserted into each of the magnet pockets, and a plurality of clearances which are in each case delimited by the magnets inserted into one of the magnet pockets and by the laminated core. A first connection channel connects a first one of the clearances which is associated with a first one of the magnet pockets to a second one of the clearances which is associated with a second one of the magnet pockets. An electric machine may include such a rotor, and a vehicle may include such an electric machine.

The invention relates to a rotor for an electric machine, to an electric machine having a rotor, to a vehicle having an electric machine, and to a method for producing a rotor.

The rotor has a laminated core (rotor core) formed from stacked electrical laminations and having magnet pockets disposed therein, and has a plurality of magnets, of which at least one is inserted into each of the magnet pockets.

Electric machines having such a rotor are increasingly used in electrically driven vehicles and hybrid vehicles, predominantly as an electric motor for driving a wheel or an axle of such a vehicle.

Such an electric motor is usually mechanically coupled to a gear mechanism for speed adaptation. Moreover, the electric motor is typically electrically coupled to an inverter which generates AC voltage, for example multi-phase AC voltage, for the operation of the electric motor, from DC voltage that is provided from a battery.

It is also possible to operate an electric machine having such a rotor as a generator for recuperating kinetic energy of a vehicle. For this purpose, the kinetic energy is first converted into electrical energy and then into chemical energy of a vehicle battery.

In the case of the rotor, it must be ensured that the magnets maintain their position in the magnet pockets, in particular at high rotational speeds. To this end, it is conventional to pot the magnets in the magnet pockets with a potting compound so that the magnets are securely fixed or secured in the laminated core.

However, the potting is complex and it may be the case that undesirable hollow spaces or air bubbles remain in the laminated core in this case. These impair the stability of the fixing of the magnets and can result in imbalance of the rotor.

Therefore, an object of the invention is to provide a rotor for an electric machine, the magnets of which can be potted in a particularly simple manner, wherein no hollow spaces or air bubbles remain in the laminated core of the rotor.

According to the invention, in order to achieve the object in a rotor of the type mentioned at the outset, it is provided that the rotor furthermore has a plurality of clearances which are in each case delimited by the magnets inserted into one of the magnet pockets and by the laminated core. Furthermore, the rotor has a first connection channel which connects a first one of the clearances which is associated with a first one of the magnet pockets to a second one of the clearances which is associated with a second one of the magnet pockets.

The clearances can be potted with a potting compound, whereby the magnets are fixed in the laminated core, in particular adhesively bonded to the laminated core. The potting operation represents a comparatively simple and cost-effective way of securing the magnets.

Since a first one of the clearances which is associated with a first one of the magnet pockets is connected by the first connection channel to a second one of the clearances which is associated with a second one of the magnet pockets, both clearances can be potted in a single method step. Consequently, different magnet pockets are potted in the same method step.

It is thereby unnecessary to position a nozzle, with which the resin is injected, several times for each of the magnet pockets separately. The process of potting the magnet pockets can consequently be accelerated considerably. Another advantage is that, when the casting compound is being poured in, air which is in the first clearance can be discharged outwards via the connection channel and the second clearance. It is thereby possible to completely fill with casting compound both the two clearances and the connection channel without an undesirable hollow space remaining.

In this manner, the magnets are secured in a stable manner and furthermore an imbalance of the rotor is avoided. It is therefore ensured that the rotor retains its magnetic properties in a permanent manner. Consequently, malfunction-free operation of the electric machine which comprises the rotor according to the invention is ensured.

The fact that a clearance is associated with a magnet pocket may be understood herein to mean that the clearance belongs to the magnet pocket or forms a portion of the magnet pocket. In other words, the clearance takes up some of the volume of the magnet pocket.

The laminated core may be formed from the electrical laminations by being welded, bonded, punch-bundled or secured to each other in some other manner. In particular, the laminated core can have a cylindrical shape. Furthermore, each electrical lamination can have a central opening, which openings, in the mounted state, form an axial bore of the laminated core through which a rotor shaft of the rotor can lead. The axis of the rotor shaft or of the rotor corresponds to the axial axis of the laminated core.

Furthermore, the laminated core can be composed of a plurality of laminated core segments, wherein one or a plurality of the laminated core segments can be rotationally offset in the circumferential direction with respect to one or a plurality of the other laminated core segments. In this manner, the rotation behaviour of the rotor can be improved. In particular, the laminated cores can be rotated relative to each other so that the axial clearances, which otherwise extend parallel with the rotor axis, extend obliquely relative to the rotor axis.

In addition to the rotor, the electric machine may have a stator relative to which the rotor is rotatable. The stator can have a further laminated core (stator core) which is formed from stacked electrical laminations. In addition, the stator may have windings of electrical conductors, for example as coil windings or flat wire windings. The machine can additionally be equipped with a housing in which the rotor and the stator are received, wherein the rotor shaft may protrude from the housing.

The magnets which are inserted into one of the magnet pockets are preferably lined up axially beside each other. During the assembly of the rotor, the magnets can thereby be inserted or pushed readily one after the other into the magnet pocket. The axially lined-up magnets are referred to as a “magnet stack”. The rotor may have a plurality of such magnet stacks which are each arranged in a magnet pocket. Alternatively to a magnet stack, a single magnet can also be arranged in one or more of the magnet pockets.

A clearance can be formed on a lateral face of a magnet pocket, wherein another clearance is formed on an opposite lateral face of the magnet pocket. As a result, the magnets which are arranged between the two clearances can be secured particularly well with potting.

The two clearances may be separated from one another by a magnet or a magnet stack. The volume of the clearances is generally much smaller than the volume of the magnet stack, so as to limit the quantity of potting compound required to fill the clearances.

In the context of the invention, there may be provision for the first clearance, the second clearance and the first connection channel to belong to a continuous channel which connects a filling opening to a venting opening of the rotor. It is thereby possible to completely fill the continuous channel with potting compound in a single method step.

In one embodiment of the invention, the first connection channel extends at an axial side of the laminated core. In this instance, it is preferably the axial aside at which the filling opening is arranged. Alternatively, it may be the opposite axial side.

Another embodiment of the invention makes provision for a second connection channel which extends at an opposite axial side of the laminated core and which connects the second clearance to a third one of the clearances. Consequently, the first connection channel and the second connection channel each extend at a different axial side.

The third clearance is preferably associated with the second magnet pocket, in the same manner as the second clearance. Alternatively, the third clearance can be associated with a third magnet pocket. Additionally, the rotor may have additional connection channels for connecting additional clearances to the previously mentioned clearances.

A preferred embodiment of the invention makes provision for the first connection channel and/or the second connection channel each to extend in an end plate of the rotor. Such an end plate is arranged at an axial side of the laminated core. A connection channel may, for example, be in the form of a groove of the end plate, preferably at an inner side of the end plate.

It is also possible for the rotor according to the invention not to have any end plate. In this case, the first connection channel and/or the second connection channel may each extend in an end lamination of the laminated core. Such an end lamination is arranged at an axial side of the laminated core. A connection channel may be formed, for example, in a curvature of the end lamination.

The filling opening and the venting opening are preferably arranged at the same axial side of the laminated core. Alternatively, the filling opening and the venting opening can be arranged at different axial sides of the laminated core.

A particularly preferred embodiment of the rotor makes provision for two, three or four continuous channels which correspond to the above-mentioned continuous channel and which each connect a different filling opening of the rotor to a different venting opening of the rotor. In this manner, many of the connection channels or even all of the connection channels can be connected so that the magnets of the rotor can be potted in a small number of method steps or in a single method step.

As already mentioned, the magnets of the rotor according to the invention are preferably potted with a potting compound that fills the clearances. Normally, the clearances are completely filled with potting compound. However, it is also possible to only partially fill the clearances with potting compound. Inter alia, an epoxy resin or an adhesive can be used as the potting compound.

In addition, the invention relates to an electric machine having a rotor of the type described. In addition to the rotor, the electric machine can have a stator with respect to which the rotor can be rotated. The stator can have a further laminated core (stator core) which is formed from stacked electrical laminations. In addition, the stator may have windings of electrical conductors, for example, in the form of coil windings or flat wire windings.

Furthermore, the invention relates to a vehicle having such an electric machine which is provided for driving the vehicle. The machine can in particular drive a wheel or an axle of the vehicle.

The invention furthermore relates to a method for producing a rotor for an electric machine, comprising the following steps:
forming a laminated core, in which magnet pockets are disposed, from stacked electrical laminations;
inserting at least one magnet into each of the magnet pockets, wherein clearances which are each delimited by the magnets which are inserted in one of the magnet pockets and the laminated core remain,
forming at least a first connection channel which connects a first of the clearances which is associated with a first one of the magnet pockets to a second one of the clearances which is associated with a second one of the magnet pockets, and
potting the magnets, which have been inserted into the magnet pockets, with a potting compound.

In the method, clearances which are associated with different magnet pockets can be potted simultaneously or in the same method step, whereby the method can be carried out particularly simply and quickly.

In the method, it is particularly preferable for the potting compound to flow from the first clearance through the connection channel into the second clearance.

The invention will be explained hereunder by means of an exemplary embodiment with reference to the Figures. The Figures are schematic illustrations in which:

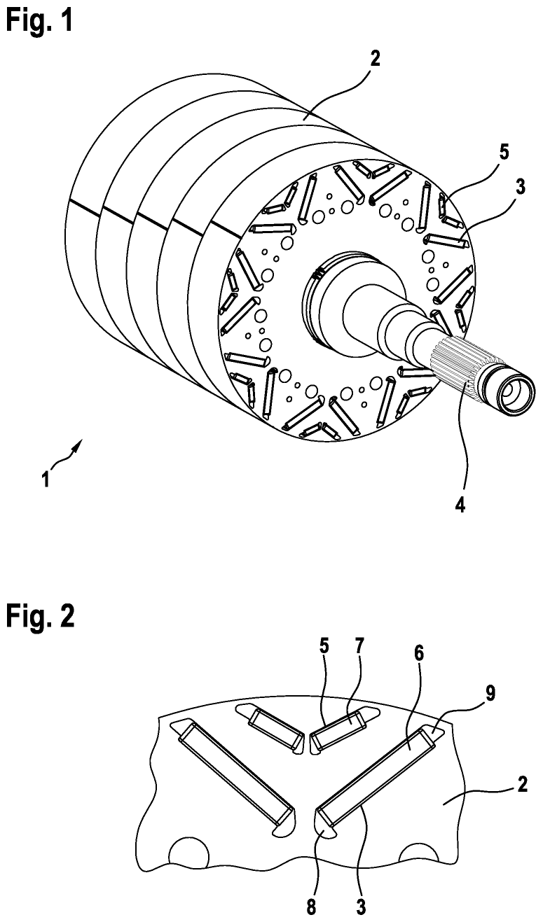

FIG. 1 shows a perspective view of a laminated core and of a rotor shaft of a rotor according to the invention;

FIG. 2 shows a detail of the laminated core shown in FIG. 1,

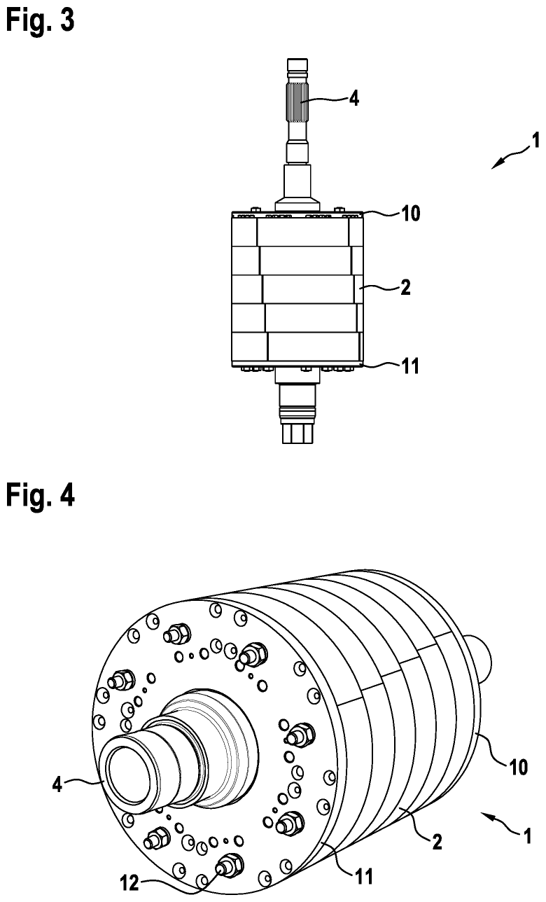

FIG. 3 shows the rotor provided with end plates, in a lateral view,

FIG. 4 shows a perspective view of the rotor,

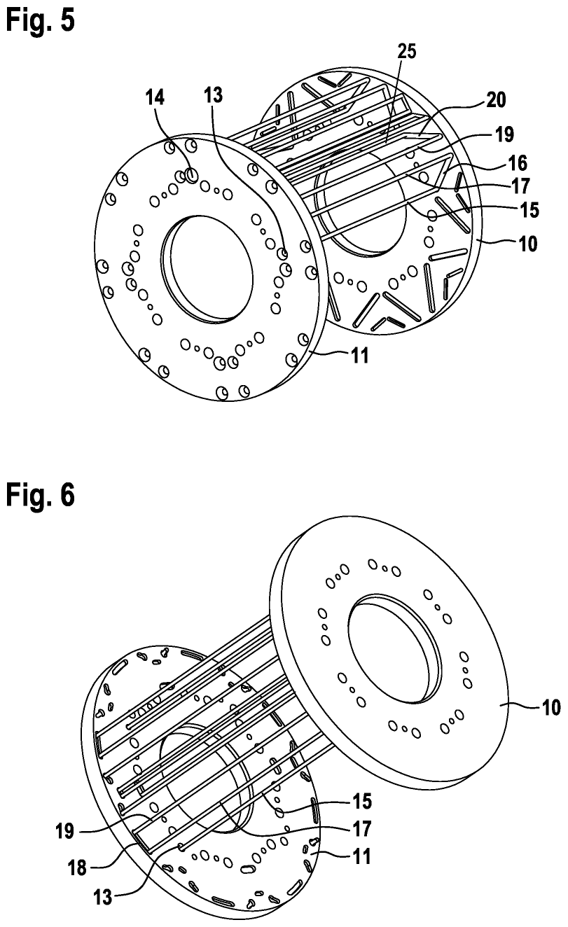

FIG. 5 shows a perspective view of the rotor without the laminated core and the rotor shaft,

FIG. 6 shows a view of the arrangement, shown in FIG. 5, from another perspective, and

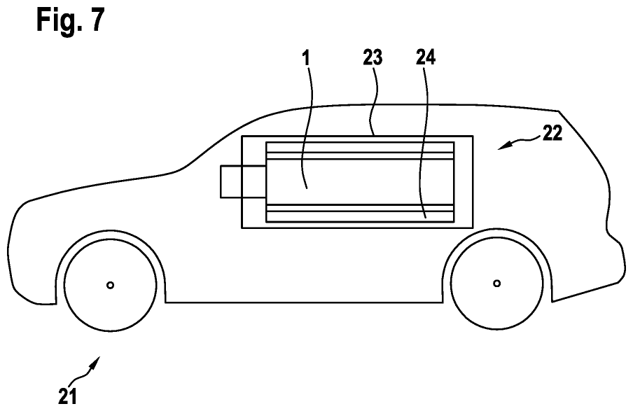

FIG. 7 shows a vehicle having an electric machine having the rotor.

The rotor 1 shown in FIG. 1 is provided for an electric machine and comprises a cylindrical laminated core 2 which is composed of stacked electrical laminations. The laminated core 2 encloses a rotor shaft 4 with form fit and/or force fit. The electrical laminations are divided over five laminated core segments, wherein the rotor 1 could also instead have a different number of laminated core segments or a non-segmented laminated core. Each laminated core segment is rotated with respect to an adjacent laminated core segment in a circumferential direction about the same rotation angle.

FIG. 2 shows a detail of the rotor 1. It can be seen here that a plurality of magnet pockets 3, 5 which each extend from the shown axial side of the laminated core 2 as far as the opposite axial side thereof are arranged in the laminated core 2 along the circumference of the rotor 1. A plurality of cuboidal magnets 6, 7 are lined up axially in series in each magnet pocket 3, 5, forming a magnet stack. A total of 32 such magnet stacks are accommodated in the laminated core, although a different number of magnet stacks can also be used.

The magnet pockets 3, 5 are of different sizes. In particular, a distinction can be made between relatively large magnet pockets 3 which have relatively long axial openings, and relatively small magnet pockets 5 which have relatively short axial openings. Relatively large magnets 6 with relatively long axial end faces are lined up axially in series in the relatively large magnet pockets 3, whereas relatively small magnets 7 with relatively short axial end surfaces are lined up axially in series in the relatively small magnet pockets 5.

Two adjacent relatively large magnet pockets 3 are arranged symmetrically relative to each other with respect to a radial axis (not shown) of the laminated core 2, wherein the two magnet pockets 3 form a V-shape which is open radially outwardly. Equally, two adjacent relatively small magnet pockets 5 are arranged symmetrically with respect to one another in relation to the radial axis, with the two magnet pockets 5 likewise forming a V shape.

Situated adjacent to each magnet stack are two clearances 8, 9, which are in each case delimited by the magnet stack and by the laminated core 2. In other words, each magnet pocket 3, 5 has a clearance 8 which is formed on a lateral face of the magnet pocket 3, 5 and a clearance 9 which is formed on an opposite lateral face of the magnet pocket 3, 5, between which a magnet stack is located. The clearances 8, 9 each extend from an axial side as far as the opposite axial side of the laminated core 2, wherein the clearance 9 extends radially outside the clearance 8.

FIG. 3 shows the rotor 1 having a first end plate 10 and a second end plate 11 in a lateral view. The end plates 10, 11 are disposed on opposite axial sides of the laminated core 2 and are connected to one another using clamping elements. As a result, the laminated core 2 is permanently impinged with a compressive force or preload force. It is avoided in this way that the electrical laminations of the laminated core 2 delaminate, in particular at high rotational speeds of the rotor 1.

FIG. 4 shows a perspective view of the rotor 1 having the end plates 10, 11. The clamping elements are in the form of screws 12, the ends of which can be seen in FIG. 4. Each of the eight screws 12 extends axially through the first end plate 10, the laminated core 2 and the second end plate 11. For this purpose, the end plates 10, 11 and the laminated core 2 are in each case provided with axial bores. The heads of the screws 12 (not visible) are arranged on the first end plate 10. The screws 12 are screwed with nuts at the second end plate 11.

FIG. 5 shows a view of the rotor from the same perspective as in FIG. 4, wherein the laminated core 2, the rotor shaft 4 and the screws 12 are not illustrated. On the other hand, the two end plates 10, 11 and axial clearances and connection channels which are filled with the potting compound are shown.

The second end plate 11 has a filling opening 13 which is connected to a venting opening 14 via the clearances and connection channels. Consequently, the clearances and connection channels form a continuous channel which extends from the filling opening 13 as far as the venting opening 14. In total, four such continuous channels are present in the rotor 1 but only one of them is shown.

There belongs inter alia to the continuous channel a clearance 15 which extends axially from the filling opening 13 as far as the first end plate 10 and which is part of a first magnet pocket.

The first clearance 15 is adjoined by a connection channel 16 which is formed in the first end plate 10 and which extends between a magnet stack (not shown in FIG. 5) which is arranged in the first magnet pocket and the first end plate 10.

The connection channel 16 is adjoined by an additional clearance 17 which extends axially from the first end plate 10 as far as the second end plate 11 and which is part of the first magnet pocket. With reference to the claims, the clearance 17 may also be referred to as a “first clearance”.

If FIG. 6 which shows the rear side, that is to say, the inner side, of the second end plate 11 is now viewed, it can be seen that an additional connection channel 18 adjoins the clearance 17. The connection channel 18 is formed in the second end plate 11 and extends as far as an additional clearance 19. With reference to the claims, the connection channel 18 may be referred to as the “first connection channel” and the clearance 19 as the “second clearance”.

The clearance 19 is part of a second magnet pocket and extends axially from the second end plate 11 as far as the first end plate 10. At that location, the clearance 19 is adjoined by an additional connection channel 20 which is formed in the first end plate 10 and which extends between a magnet stack which is arranged in the second magnet pocket and the first end plate 10. With reference to the claims, the connection channel 20 may be referred to as the “second connection channel”.

The connection channel 20 connects the clearance 19 to an additional clearance 25 which extends axially from the first end plate 10 as far as the second end plate 11 and which is part of the second magnet pocket. With reference to the claims, the clearance 25 may be referred to as the “third clearance”. As an alternative to the second magnet pocket, the third clearance in another embodiment of the invention may also be part of a third magnet pocket.

The clearance 25 is adjoined by additional connection channels and clearances which extend as far as the venting opening 14. The continuous channel which is formed by the mentioned clearances and connection channels extends in a meandering manner between the two end plates 10, 11 and connects the venting opening 13 to the venting opening 14. The channel is characterized in that it can be potted with potting compound in a single method step. To this end, the potting compound can be introduced or pressed into the filling opening 13 so that the potting compound flows as far as the venting opening 14.

In the illustrated embodiment of the invention, the continuous channel extends over approximately one-quarter of the circumference of the laminated core 2. However, other embodiments of the invention in which such a channel extends over approximately half of the circumference or over the entire circumference are also possible.

As an alternative to the configuration of the connection channels in the first end plate 10 and the second end plate 11 as shown in FIGS. 5 and 6, the connection channels can also be formed in end laminations of the laminated core, for example, using curvatures of the end laminations.

FIG. 7 schematically shows a vehicle 21 having an electric machine 22 which serves for driving the vehicle 21. The electric machine 22 has a housing 23 in which the rotor 1 and a stator 24, which surrounds the rotor 1, are accommodated.

In the method according to the invention for producing the rotor 1, the following method steps are carried out:

In a first step, the laminated core 2 in which the magnet pockets 3, 5 are arranged is formed from stacked electrical laminations.

In a second step, the magnets 6, 7 are inserted in each of the magnet pockets 3, 5, wherein there remain clearances which are each delimited by the magnets 6, 7 which are inserted in one of the magnet pockets 3, 5 and the laminated core 2.

In a third step, there is formed a first connection channel which connects a first one of the clearances which is associated with a first one of the magnet pockets 3, 5 to a second one of the clearances which is associated with a second one of the magnet pockets.

In a fifth step, the magnets 6, 7 which are inserted in the magnet pockets 3, 5 are potted with a potting compound. In this case, a portion of the potting compound can flow from the first clearance through the first connection channel into the second clearance.

For potting, a nozzle of a filling device is placed on the filling opening 13 (or each filling opening) of the first end plate 10. The potting compound is pressed with excess pressure into the clearances so that the potting compound flows through the axially extending connection channels, as explained with reference to FIG. 5 and FIG. 6. In the meantime, air is discharged from the laminated core 2, in particular from the clearances and connection channels, through the venting opening 14. This allows a bubble-free potting of the magnets 6, 7 so that they are securely secured to the laminated core 2.

After the potting, the potting compound is cured. Furthermore, the rotor shaft 4 is introduced through an axially extending central through-opening of the laminated core 2 (and corresponding openings of the end plates 10, 11) so that the laminated core 2 encloses the rotor shaft 4 and is secured thereto.

### LIST OF REFERENCE SIGNS

1 Rotor
2 Laminated core
3 Magnet pocket
4 Rotor shaft
5 Magnet pocket
6 Magnet
7 Magnet
8 Clearance
9 Clearance
10 First end plate
11 Second end plate
12 Screw
13 Filling opening
14 Venting opening
15 Clearance
16 Channel portion
17 Clearance
18 Connecting channel
19 Clearance
20 Connecting channel
21 Vehicle
22 Electric machine
23 Housing
24 Stator
25 Clearance

1. Rotor for an electric machine, comprising:
a laminated core formed from stacked electrical laminations and having magnet pockets arranged therein,
a plurality of magnets, of which at least one is inserted into each of the magnet pockets,
a plurality of clearances which are in each case delimited by the magnets inserted into one of the magnet pockets and by the laminated core, and
a first connection channel which connects a first one of the clearances which is associated with a first one of the magnet pockets to a second one of the clearances which is associated with a second one of the magnet pockets.

2. Rotor according to claim 1, wherein the first clearance, the second clearance and the first connection channel belong to a continuous channel which connects a filling opening to a venting opening of the rotor.

3. Rotor according to claim 1, wherein the first connection channel extends at an axial side of the laminated core.

4. Rotor according to claim 3, having a second connection channel which extends at an opposite axial side of the laminated core and which connects the second clearance to a third one of the clearances.

5. Rotor according to claim 4, wherein the third clearance is associated with the second magnet pocket or a third magnet pocket.

6. Rotor according to claim 4, wherein the first connection channel extends in an end plate of the rotor and/or the second connection channel extends in an end plate of the rotor.

7. Rotor according to claim 4, wherein the first connection channel extends in an end lamination of the laminated core and/or the second connection channel extends in an end lamination of the laminated core.

8. Rotor according to claim 2, wherein the filling opening and the venting opening are arranged at the same axial side or at different axial sides of the laminated core.

9. Rotor according to claim 8, having two, three or four continuous channels which correspond to the continuous channel and which each connect a different filling opening of the rotor to a different venting opening of the rotor.

10. Rotor according to claim 1, wherein the laminated core comprises a plurality of laminated core segments which are stacked in an axial direction, wherein one of the laminated core segments is rotated in the circumferential direction with respect to an adjacent one of the laminated core segments.

11. Rotor according to claim 1, wherein the magnets are potted with a potting compound which is introduced into the clearances.

12. Electric machine having a rotor according to claim 1.

13. Vehicle having an electric machine according to claim 12, which is provided to drive the vehicle.

14. Method for producing a rotor for an electric machine, comprising the following steps:
forming a laminated core, in which magnet pockets are disposed, from stacked electrical laminations.
inserting at least one magnet into each of the magnet pockets, wherein clearances which are each delimited by the magnets which are inserted in one of the magnet pockets and the laminated core remain,
forming at least a first connection channel which connects a first of the clearances which is associated with a first one of the magnet pockets to a second one of the clearances which is associated with a second one of the magnet pockets, and
potting the magnets, which have been inserted into the magnet pockets, with a potting compound.

15. Method according to claim 14, wherein some of the potting compound flows from the first clearance through the first connection channel into the second clearance.

16. Rotor according to claim 2, wherein the first connection channel extends at an axial side of the laminated core.

17. Rotor according to claim 5, wherein the first connection channel extends in an end plate of the rotor and/or the second connection channel extends in an end plate of the rotor.

18. Rotor according to claim 5, wherein the first connection channel extends in an end lamination of the laminated core and/or the second connection channel extends in an end lamination of the laminated core.

19. Rotor according to claim 3, wherein the filling opening and the venting opening are arranged at the same axial side or at different axial sides of the laminated core.

20. Rotor according to claim 2, wherein the laminated core comprises a plurality of laminated core segments which are stacked in an axial direction, wherein one of the laminated core segments is rotated in the circumferential direction with respect to an adjacent one of the laminated core segments.
